(19) United States
(12) Patent Application Publication
(10) Pub. No.: US 2015/0350439 A1
(43) Pub. Date: Dec. 3, 2015

(54) REMOTE ASSISTANCE CUSTOMER INFORMATION

(71) Applicant: NCR Corporation, Duluth, GA (US)

(72) Inventor: Philip Holden, Edinburgh (GB)

(73) Assignee: NCR Corporation, Duluth, GA (US)

(21) Appl. No.: 14/291,480

(22) Filed: May 30, 2014

(51) Int. Cl. H04M 3/51

(52) U.S. Cl. CPC H04M 3/5183

(57) ABSTRACT

A customer operating a device requests remote assistance from a remote assistance center. A remote assistance interface executing on the device interacts with a remote assistance manager to provide the customer with information relevant to receiving remote assistance in a time and manner acceptable to the customer and based on customer navigation and selection of options associated with the information.

### BACKGROUND

More and more customers of enterprises are encountering queues when interacting with the enterprises for assistance. In real life, when a customer sees a physical queue of other customers at an in-person retail assistance counter, the customer makes a decision as to whether to wait in the physical queue based on the length of the queue and/or, perhaps, the identity of agent(s) assisting the customers at the retail assistance counter. If the customer is in a hurry and the queue is long, he/she may decide to come back at a later date or time for assistance. If the customer has plenty of time but wants to speak with a particular agent, he/she may choose to let a few people ahead of him/her in the queue when his/her time is up for assistance in the queue in order to get the particular agent that the customer desires.

However, when a customer is confronted with a call center (such as online via a connected device or via a phone call), the customer is completely unaware of the state of the queue and the identities of the agents manning the queue for customer assistance. So, the customer cannot determine how many other customers are in front of them in the online or call queue, cannot determine how fast the queue is progressing, and cannot determine which agents are answering which calls or online requests.

Therefore, one major issue with a call center is that from the perspective of the customer it appears random and discontinuous. For example, a customer desiring information or assistance for a mortgage application may have to make multiple calls to the call center and the customer may also need to keep repeating the same details over and over again to different agents until the customer receives assistance that is satisfactory to the customer.

Therefore, it is desirable to provide improved mechanisms relevant to a remote assistance center's operational details and state to waiting customers.

### SUMMARY

In various embodiments, methods and an SST for providing remote assistance customer information are presented.

According to an embodiment, a method for providing remote assistance customer information is presented. Specifically, an interface is provided for remote assistance information. The interface presents within a rendered screen on a display the remote assistance information, which is relevant to a state of remote real-time assistance.

### BRIEF DESCRIPTION OF THE DRAWINGS

FIG. 1 is a diagram of a banking retail system providing remote teller assistance customer information, according to an example embodiment.

FIG. 2 is a diagram of a method for providing remote assistance customer information, according to an example embodiment.

FIG. 3 is a diagram of another method for providing remote assistance customer information, according to an example embodiment.

FIG. 4 is a diagram of a Self-Service Terminal, according to an example embodiment.

### DETAILED DESCRIPTION

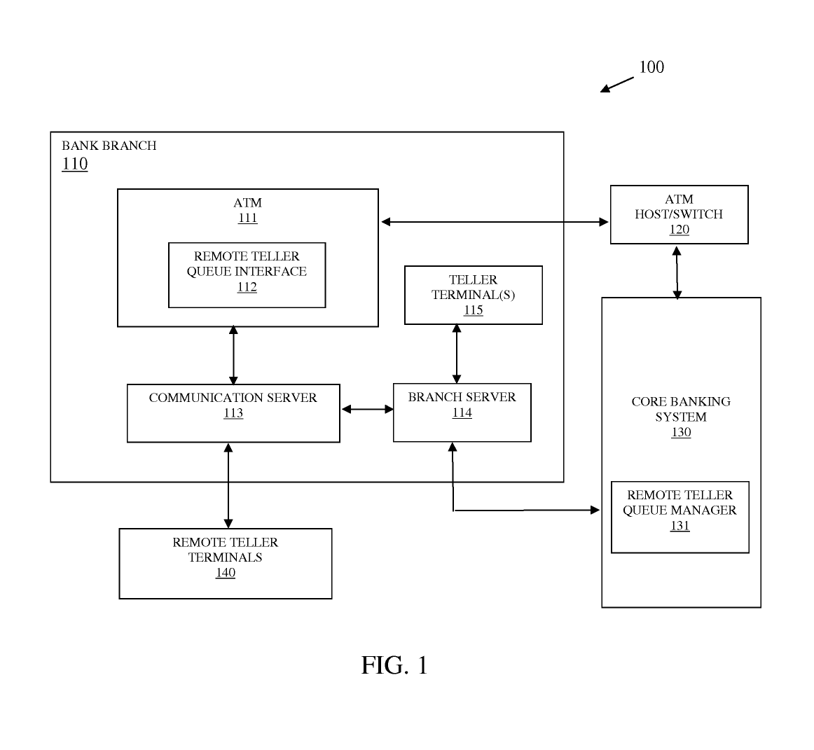

FIG. 1 is a diagram of a banking retail system 100 providing remote teller assistance customer information, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of deposit visualization, presented herein and below.

The banking retail system 100 includes a bank branch 110, an ATM host/switch 120, a core banking system 130, and one or more remote teller terminals 140. The bank branch 110 includes an ATM 111 (having a remote teller queue interface 112), a communication server 113, a branch server 114, and one or more teller terminals 115. The core banking system 130 includes a remote teller queue manager 131.

During operation, a customer operating the ATM 111 to conduct a transaction may request assistance before, during, or after the transaction using the remote teller queue interface 112. Any financial transactions to deposit or receive cash from the ATM 111 make a network connection with a remote ATM host/switch 120 that routes and transaction details along with approval or denial through the core banking system 130.

Local assistance from a local teller can be achieved by direct customer request or by teller unsolicited offers for assistance. Such local assistance connects from the ATM 111 through the communication server 113 to the branch server 114 and then to a local teller terminal 115 operated by a local teller.

The branch server 114 interacts through a network connection with the core banking system 130.

When the customer requests remote assistance through the remote teller queue interface 112 while operating the ATM 111, the request for remote assistance is routed through the communication server 113 to the branch server 114. The branch server 114 connects to the core banking system 130 with the request for remote assistance. The request for remote assistance is processed within the core banking system 130 by the remote teller queue manager 131.

The remote teller queue interface 112 may provide a variety of options selectable by the customer, each selectable option providing information, such as but not limited to, anticipated wait time for an available remote teller operated at one of the remote teller terminals 140, list of available remote tellers by name (along with anticipated wait times for each remote teller by name), selection of a remote teller by name, a list of available remote tellers by function or skill (e.g., loans, savings, etc.), list of available remote tellers by spoken language skills (e.g., five minutes for English speaking remote teller, three minutes for Spanish speaking remote teller, etc.), statistics showing what time of day the remote tellers service remote assistance requests the quickest (most efficient), a list of remote tellers by name that the customer has previous used for remote assistance (along with dates and times for such previous usage), and, perhaps, any previous quality ratings the customer may have given specific remote tellers that are presently available for providing remote assistance.

The remote teller queue interface 112 may be presented as a navigation tool on the ATM 111 allowing the customer to select more or less specific options.

When the customer selects an option from the remote teller queue interface 112 at the ATM 111 it is routed through the communication server 113 to the branch server 114 to the remote teller queue manager 131.

The remote teller queue manager 131 maintains detailed information regarding: the customer, the customer's transaction history, customer loyalty details (including preferences and profiles for the customer), the remote tellers, a history for remote teller assistance, metrics for remote teller assistance, current remote tellers available for remote assistance, skills for the remote tellers, and a current state of the current remote assistance.

The remote teller queue manager 131 receives the customer selection and processes the maintained detailed information to satisfy the customer selection. The results are then communicated from the core banking system 130 to the branch server 114 and on to the communication server 113 where it is communicated to the remote teller queue interface 112.

The remote teller queue interface 112 then presents the results from the original customer selection in a variety of formats within a rendered screen on a display of the ATM 111. For example, the results may be presented in a graph chart, a bar chart, tabular format, pictorial format, text format, or a combination of these formats. Moreover, the results may be presented in an interactive format that is processed by the remote teller queue interface 112 to provide more detailed or less detailed information regarding the results. For example, a first presentation of the results may indicate ten available English speaking remote tellers available for remote assistance. The customer may double click or select another option to expand the ten available English speaking remote tellers, which results in a second presentation showing names, skills, and wait times for each of the ten remote tellers. This is but one example and a variety of other situations can exist, without departing from the teachings presented herein.

When the customer is ready to be serviced by a selected or chosen remote teller based on the customer selections, the remote teller terminal 140 for the remote teller is connected to the ATM 111 through the communication server 113.

In an embodiment, the remote teller queue manager 131 and the remote teller queue interface 112 are enabled with WebRTC (Web Real-Time Communication), which is an Application Programming Interface (API) browser-to-browser real-time communication. Thus, while the customer is waiting for a selected remote teller the remote teller queue manager 131 has access to render one or more screens on a display of the ATM 111 through interaction with the remote teller queue interface 112. So, a current state of the remote teller queue can be graphically represented in real time to the customer operating the ATM 111. Again, a variety of other real-time presentations regarding current remote assistance can be rendered to screens on the display of the ATM 111.

It is also noted that the state of the remote teller queue may be presented within a rendered screen on the display of the ATM 111 (perhaps in a graphical format) even before the customer begins to operate the ATM 111. This can be an overlaid rendered screen that may be decreased in size so as to not obstruct other rendered ATM transactional screens. Alternatively, a selection on the rendered screen can be activated by the customer to activate a presentation of the state.

In an embodiment, when the customer is connected with the remote teller, the resulting communication session can be: audio-based, audio and video based, text based, avatar based, or a combination of these things.

One now appreciates how remote assistance information may be presented to a customer operating an ATM 111 in a manner that can be driven by the customer for making informed and directed decisions about remote assistance. This information can include real-time state data for remote assistance and well as, perhaps, historical data relevant to remote assistance for an enterprise.

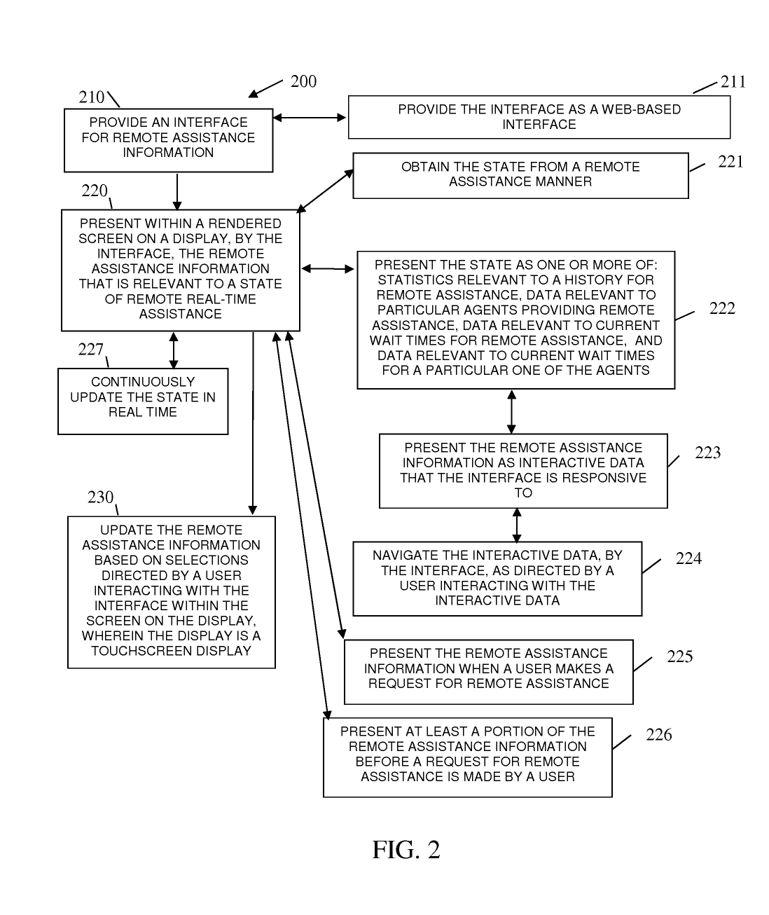

Some of embodiments of the FIG. 1 and other embodiments are now discussed with reference to the FIGS. 2-4.

FIG. 2 is a diagram of a method 200 for providing remote assistance customer information, according to an example embodiment. The software module(s) that implements the method 200 is referred to as a “remote assistance interface.” The remote assistance interface is implemented as executable instructions programmed and residing within memory and/or a non-transitory computer-readable (processor-readable) storage medium and executed by one or more processors of a device. The processor(s) of the device that executes the remote assistance interface are specifically configured and programmed to process the remote assistance interface. The remote assistance interface has access to one or more network connections during its processing. The network connections can be wired, wireless, or a combination of wired and wireless.

In an embodiment, the device that executes the remote assistance interface is the ATM 100 of the FIG. 1.

In an embodiment, the device that executes the remote assistance interface is a Self-Service Terminal (SST).

In an embodiment, the device that executes the remote assistance interface is a kiosk.

In an embodiment, the device that executes the remote assistance interface is one of: a laptop, a desktop computer, a phone, a tablet, and a wearable processing device.

In an embodiment, the remote assistance interface is the remote teller queue interface 112 of the FIG. 1.

At 210, the remote assistance interface provides an interface for remote assistance information. The interface permitting a user (operating a device that executes the remote assistance interface) to acquire metrics and detailed information relevant to the user making a decision regarding obtaining real-time remote assistance from a remote assistance service.

According to an embodiment, at 211, the remote assistance interface provides the interface as a web interface, such as an interface enabled with a WebRTC API and browser based.

At 220, the remote assistance interface uses the interface to present, within a rendered screen on a display, the remote assistance information. The remote assistance information is relevant to a state of the remote real-time assistance. The state can include a variety of information, such as the information and details discussed above with reference to the FIG. 1.

According to an embodiment, at 221, the remote assistance interface obtains the state from a remote assistance manager.

In an embodiment of 221, the remote assistance manager is the remote teller queue manager 131 of the FIG. 1.

In an embodiment, at 222, the remote assistance interface presents the state as one or more of: statistics relevant to a history for the remote assistance, data relevant to particular agents that provide the remote assistance, data relevant to current wait times for the remote assistance, and data relevant to current wait times for a particular one of the agents.

In an embodiment of 222 and at 223, the remote assistance interface presents the remote assistance information as interactive data that the interface is responsive to. That is, portions of the remote assistance information can drive actions of the interface when selected or activated by a user.

In an embodiment of 223 and at 224, the interface, provided by the remote assistance interface, navigates the interactive data as directed by the user interacting with the interactive data.

In an embodiment, at 225, the remote assistance interface presents the remote assistance information when a user makes a request for remote assistance.

In an embodiment, at 226, the remote assistance interface presents at least a portion of the remote assistance information before a request for remote assistance is made by a user. So, the device that executes the remote assistance interface may continuously provide portions of information relevant to a remote assistance queue (the user can see the portions of information before making a request for assistance or activating options associated with the interface).

In an embodiment, at 227, the remote assistance interface continuously updates the state within the rendered screen in real time.

According to an embodiment, at 230, the remote assistance interface updates the remote assistance information based on selections directed by a user interacting with the interface within the screen on the display; the display is a touchscreen display.

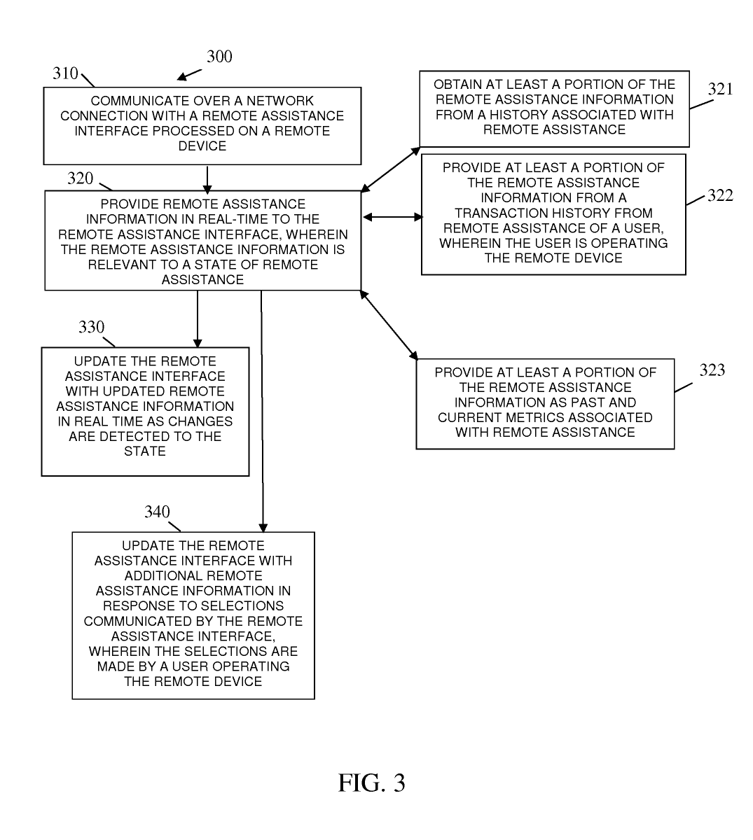

FIG. 3 is a diagram of another method 300 for providing remote assistance customer information, according to an example embodiment. The software module(s) that implements the method 300 is referred to as a “remote assistance manager.” The remote assistance manager is implemented as executable instructions programmed and residing within memory and/or a non-transitory computer-readable (processor-readable) storage medium and executed by one or more processors of a device. The processors that execute the remote assistance manager are specifically configured and programmed to process the remote assistance manager. The remote assistance manager has access to one or more network connections during its processing. The network connections can be wired, wireless, or a combination of wired and wireless.

In an embodiment, the device that executes the remote assistance manager is part of the core banking system 130 of the FIG. 1.

In an embodiment, the device that executes the remote assistance manager is an enterprise service for a retail establishment.

In an embodiment, the device that executes the remote assistance manager is part of a cloud processing environment.

In an embodiment, the remote assistance manager is the remote teller queue manager 131 of the FIG. 1.

The remote assistance manager interacts with the remote assistance manager of the FIG. 2 to provide a customer with information relevant to a remote assistance queue on a customer-operated device.

At 310, the remote assistance manager communicates over a network connection with a remote assistance interface processed on a remote device. Here, the remote device is the device being operated by a user, such as the ATM 111 of the FIG. 1 or the device that executes the remote assistance interface of the FIG. 2.

At 320, the remote assistance manager provides remote assistance information in real time to the remote assistance interface. The remote assistance information is relevant to a state of remote assistance that a customer operating the remote device is attempting to make an informed decision regarding obtaining remote assistance.

In an embodiment, at 321, the remote assistance manager obtains at least a portion of the remote assistance information from a history associated with providing remote assistance.

In an embodiment, at 322, the remote assistance manager provides at least a portion of the remote assistance information from a transaction history of a user (who is operating the remote device).

In an embodiment, at 323, the remote assistance manager provides at least a portion of the remote assistance information as past and current metrics associated with the remote assistance.

According to an embodiment, at 330, the remote assistance manager updates the remote assistance interface with updated remote assistance information in real time as changes are detected to the state of the remote assistance.

In an embodiment, at 340, the remote assistance manager updates the remote assistance interface with additional remote assistance information in response to selections communicated by the remote assistance interface. Again, the selections are made by a user operating the remote device.

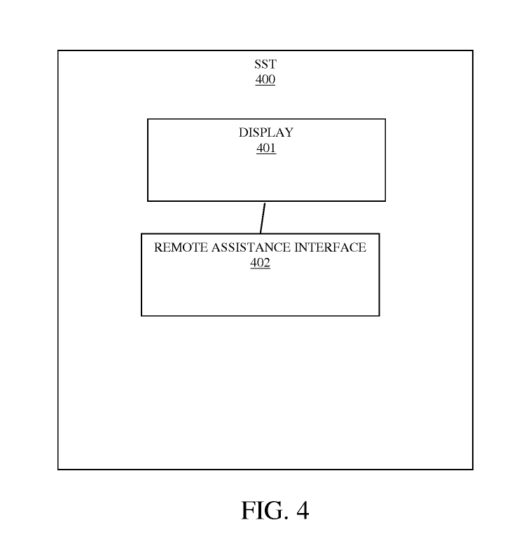

FIG. 4 is a diagram of a SST 400, according to an example embodiment. The SST 400 includes a variety of hard ware components and software components. The software components of the SST 400 are programmed and reside within memory and/or a non-transitory computer-readable medium and execute on one or more processors of the SST 400. The SST 400 communicates one or more networks, which can be wired, wireless, or a combination of wired and wireless.

In an embodiment, the SST 400 is the ATM 100.

In an embodiment, the SST 400 is a kiosk.

The SST 400 includes a display 401 and a remote assistance interface 402.

In an embodiment, the display 401 is a touchscreen.

The remote assistance interface 402 is adapted and configured to: execute on the SST 400, render a screen on the display 401 that presents remote assistance information relevant to a state of remote assistance, and present selectable options within the screen for a user to select to alter the details, associated with the remote assistance information.

In an embodiment, the remote assistance information is relevant to real-time video agent assistance during a transaction being conducted by a user at an ATM (which is the SST 400).

In an embodiment, the remote assistance interface 402 is further adapted and configured to communicate in real time with a remote assistance manager to obtain the remote assistance information. In an embodiment, the remote assistance manager is the remote assistance manager discussed with reference to the FIG. 3. In an embodiment, the remote assistance manager is the remote teller queue manager 131 of the FIG. 1.

In an embodiment, the remote assistance interface 402 is further adapted and configured to dynamically obtain at least some of the details from the remote assistance manager (of the previous discussed embodiments) when missing from the remote assistance information.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
providing an interface for remote assistance information; and
presenting within a rendered screen on a display, by the interface, the remote assistance information that is relevant to a state of remote real-time assistance.

2. The method of claim 1, wherein providing further includes providing the interface as a web-based interface.

3. The method of claim 1, wherein presenting further includes obtaining the state from a remote assistance manner.

4. The method of claim 1, wherein presenting further includes presenting the state as one or more of: statistics relevant to a history for remote assistance, data relevant to particular agents providing remote assistance, data relevant to current wait times for remote assistance, and data relevant to current wait times for a particular one of the agents.

5. The method of claim 1, wherein presenting further includes presenting the remote assistance information as interactive data that the interface is responsive to.

6. The method of claim 5, wherein presenting further includes navigating the interactive data, by the interface, as directed by a user interacting with the interactive data.

7. The method of claim 1, wherein presenting further includes presenting the remote assistance information when a user makes a request for remote assistance.

8. The method of claim 1, wherein presenting further includes presenting at least a portion of the remote assistance information before a request for remote assistance is made by a user.

9. The method of claim 1, wherein presenting further includes continuously updating the state in real time.

10. The method of claim 1 further comprising, updating the remote assistance information based on selections directed by a user interacting with the interface within the screen on the display, wherein the display is a touchscreen display.

11. A method, comprising:
communicating over a network connection with a remote assistance interface processed on a remote device; and
providing remote assistance information in real-time to the remote assistance interface, wherein the remote assistance information is relevant to a state of remote assistance.

12. The method of claim 11 further comprising, updating the remote assistance interface with updated remote assistance information in real time as changes are detected to the state.

13. The method of claim 11 further comprising, updating the remote assistance interface with additional remote assistance information in response to selections communicated by the remote assistance interface, wherein the selections are made by a user operating the remote device.

14. The method of claim 11, wherein providing further includes obtaining at least a portion of the remote assistance information from a history associated with remote assistance.

15. The method of claim 11, wherein providing further includes providing at least a portion of the remote assistance information from a transaction history from remote assistance of a user, wherein the user is operating the remote device.

16. The method of claim 11, wherein providing further includes providing at least a portion of the remote assistance information as past and current metrics associated with remote assistance.

17. A Self-Service Terminal (SST), comprising:
a display; and
a remote assistance interface configured and adapted to: i) execute on the SST, ii) render a screen on the display presenting remote assistance information relevant to a state of remote assistance, and iii) present selectable options within the screen for a user to select to alter details associated with the remote assistance information.

18. The SST of claim 17, wherein the remote assistance information is relevant to real-time remote video agent assistance during a transaction being conducted by the user at an Automated Teller Machine (ATM), which is the SST.

19. The SST of claim 17, wherein the remote assistance interface is further adapted and configured to: iv) communicate in real time with a remote assistance manager to obtain the remote assistance information.

20. The SST of claim 19, wherein the remote assistance interface is further adapted and configured to dynamically obtain at least some of the details from the remote assistance manager when missing from the remote assistance information.
